(19) United States
(12) Patent Application Publication
(10) Pub. No.: US 2026/0183935 A1
(43) Pub. Date: Jul. 2, 2026

(54) ROBOT DEVICE, AND PARAMETER ADJUSTING METHOD

(71) Applicant: YAMAHA HATSUDOKI KABUSHIKI KAISHA, Iwata-shi, Shizuoka (JP)

(72) Inventor: Tomoki HARADA, Shizuoka (JP)

(73) Assignee: YAMAHA HATSUDOKI KABUSHIKI KAISHA, Iwata-shi, Shizuoka (JP)

(21) Appl. No.: 18/858,584

(22) PCT Filed: Jun. 28, 2022
(86) PCT No.: PCT/JP2022/025768

§ 371 Date: Oct. 21, 2024

(51) Int. Cl. B25J 9/00; B25J 9/16; B25J 13/06

(52) U.S. Cl. CPC B25J 9/0081; B25J 9/1653; B25J 9/1661; B25J 13/06

(57) ABSTRACT

A robotic system includes: a robot configured to perform a predetermined operation; and a controller configured to receive direct teaching of teaching an operational objective for the robot manually by a user and control the operation of the robot. The controller executes an adjustment control of adjusting a parameter to determine a manipulation feeling in the direct teaching, and is configured to, in the adjustment control: acquire, on the basis of a result of causing the user to conduct a specific task operation manually with respect to the robot, the parameter concerning the manipulation feeling and a predetermined evaluation index; calculate, on the basis of the evaluation index, a score being a mechanical evaluation value for the task operation and presenting the score to the user; and change the parameter depending on a subjective evaluation about the manipulation feeling by the user.

### CROSS-REFERENCE TO RELATED APPLICATION

This application claims benefit of priority to International Patent Application No. PCT/JP2022/025768, filed Jun. 28, 2022, the entire contents of which are incorporated herein by reference.

### BACKGROUND

### Technical Field

The present disclosure relates to a robotic system that enables adjustment of a parameter to determine a manipulation feeling in direct teaching, and a method for adjusting the parameter.

### Background Art

In use of a robotic system including an articulated robot arm and other components on a worksite, teaching work of teaching an operational objective in a necessary work for the robot arm is required. A known robotic system includes, as a function of receiving the teaching, a direct teaching function of receiving manual teaching in connection with the operational objective for the robot arm.

In the direct teaching, a manipulation feeling about a robot is desired to be comfortable for a user. A too heavy manipulation feeling has a tendency to give the user fatigue, and a too light manipulation feeling has a tendency to make it difficult to determine a position of the robot. Japanese Unexamined Patent Publication No. 2021-74788 discloses a robotic system that causes a user to conduct a specific task operation manually with respect to a robot and thereby enables adjustment of a parameter to determine a manipulation feeling in direct teaching. The robotic system reads out a manipulation feeling of the user from the conduct state of the task operation and modifies the parameter to a desired parameter for the user.

Comfortability in the direct teaching is not only determined on the basis of characteristics of the robot including a structure, a weight, and an arrangement of the robot, but also significantly influenced by characteristics and subjectivity of the user including a power contributing to the direct teaching, a posture and a way of gripping a teaching handle, and preference for lightness or heaviness in the manipulation feeling. From this perspective, such a robotic system as described in Japanese Unexamined Patent Publication No. 2021-74788 that merely mechanically adjusts the parameter may fail to enable comfortable direct teaching for a user.

### SUMMARY

The present disclosure provides a robotic system that enables comfortable direct teaching for a user, and a method for adjusting a parameter.

A robotic system according to one aspect of the present disclosure includes a robot configured to perform a predetermined operation; and a controller configured to receive direct teaching of teaching an operational objective for the robot manually by a user and control the operation of the robot. The controller executes an adjustment control of adjusting a parameter to determine a manipulation feeling in the direct teaching, and is configured to, in the adjustment control: acquire, on the basis of a result of causing the user to conduct a specific task operation manually with respect to the robot, the parameter concerning the manipulation feeling and a predetermined evaluation index; calculate, on the basis of the evaluation index, a score being a mechanical evaluation value for the task operation, and present the score to the user; and change the parameter depending on a subjective evaluation about the manipulation feeling by the user.

A method for adjusting a parameter according to another aspect of the present disclosure is a method for adjusting a parameter to determine a manipulation feeling in direct teaching of teaching an operational objective for a robot manually by a user, the direct teaching being executable in a robotic system. The method includes causing the user to conduct a specific task operation manually with respect to the robot; deriving, on the basis of a result of the conduct of the task operation, the parameter concerning the manipulation feeling and a predetermined evaluation index; calculating, on the basis of the evaluation index, a score being a mechanical evaluation value for the task operation, and presenting the score to the user; and changing the parameter depending on a subjective evaluation about the manipulation feeling by the user.

### BRIEF DESCRIPTION OF THE DRAWINGS

FIG. 1 is a schematic view of a configuration of a robotic system according to an embodiment of the present disclosure;

FIG. 2 is a block diagram showing an electric configuration of the robotic system;

FIG. 3 is a flowchart showing an adjustment control on a parameter to determine a manipulation feeling in direct teaching;

FIG. 4 is an illustration of an example task operation to be conducted by a user;

FIG. 5 is an illustration of an example task operation to be conducted by the user;

FIG. 6 is an illustration of an example task operation to be conducted by the user;

FIG. 7 is an illustration of an example interactive interface to be used in the adjustment control; and

FIG. 8A and FIG. 8B are each an illustration of an example pull-down screen image incorporated in the interactive interface.

### DETAILED DESCRIPTION

Hereinafter, an embodiment of the present disclosure will be described with reference to the accompanying drawings. A robotic system according to the present disclosure includes a robot that is configured to perform a predetermined operation. The robot typically represents an articulated robot arm including a plurality of arm elements and a plurality of operational shafts respectively for rotating the arm element. The robotic system according to the present disclosure is preferably applicable to a collaborative robotic system to be arranged in an area where an operator conducts a predetermined work. Such a collaborative robotic system adopts in many cases direct teaching of teaching an operational objective for the robot arm manually. The embodiment to be described below exemplifies a robotic system including a vertical articulated 6-axis robot arm to be taught an operational objective through the direct teaching.

### Overall Configuration of a Robotic System

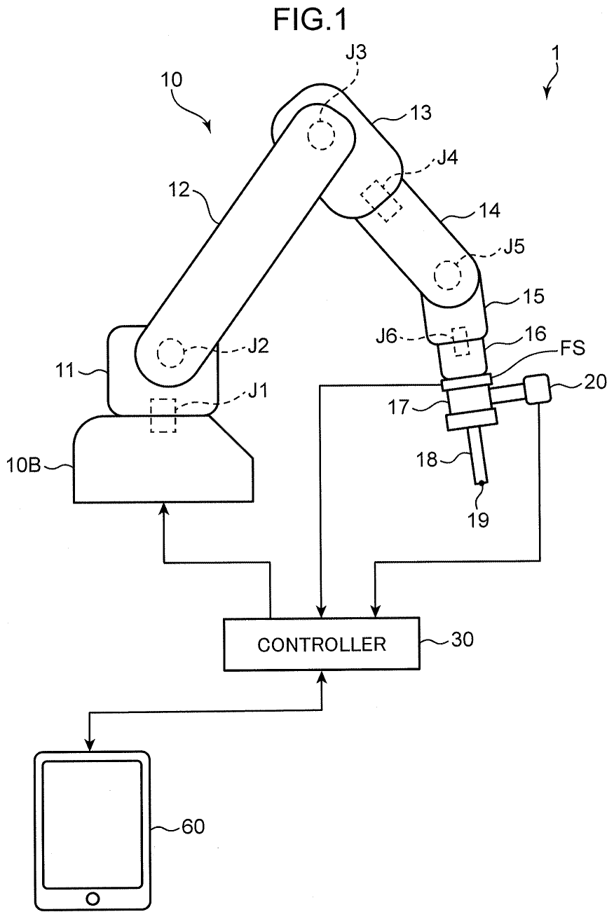

FIG. 1 is a schematic view of a robotic system 1 according to an embodiment of the present disclosure. The robotic system 1 represents a vertical articulated 6-axis robotic system including a robot arm 10, a manipulation handle 20, a controller 30, and a display 60. The robot arm 10 has six rotation shafts, that is, a first shaft J1, a second shaft J2, a third shaft J3, a fourth shaft J4, a fifth shaft J5, and a sixth shaft J6. The robot arm 10 includes arm elements of a base 10B, a first arm 11, a second arm 12, a third arm 13, a fourth arm 14, a fifth arm 15, a sixth arm 16, and a head 17. An end effector 18 and the manipulation handle 20 are attached to the head 17.

The base 10B is a housing fixedly arranged on a floor surface or a planer mounting surface of a base support or other structure. The first arm 11 is connected to an upper surface of the base 10B via the first shaft J1. The first shaft J1 is a rotation shaft extending in a vertical direction to the planar mounting surface. The first am 11 is rotatable clockwise and counterclockwise about an axis of the first shaft J1. The second arm 12 has a proximal end connected to the first arm 11 via the second shaft J2 at an upstream portion of the second arm 12. The second shaft J2 is a rotation shaft extending in a horizontal direction in parallel to the planar mounting surface. The second arm 12 is swingable about an axis of the second shaft J2.

The third arm 13 is connected to a downstream portion of the second arm 12, and has a proximal end connected to a distal end of the second arm 12 via the third shaft J3. The third arm 13 is swingable about an axis of the third shaft J3 extending in the horizontal direction. The fourth arm 14 is connected to a downstream portion of the third arm 13, and has a proximal end connected to a distal end of the third arm 13 via the fourth shaft J4. The fourth arm 14 is rotatable about an axis of the fourth shaft J4 extending in an arm axial direction.

The fifth arm 15 is connected to a downstream portion of the fourth arm 14, and has a proximal end connected to a distal end of the fourth arm 14 via the fifth shaft J5. The fifth arm 15 is swingable about an axis of the fifth shaft J5 extending in the horizontal direction. The sixth arm 16 is connected to a downstream portion of the fifth arm 15, and has a proximal end connected to a distal end of the fifth arm 15 via the sixth shaft J6. The sixth arm 16 is rotatable about an axis of the sixth shaft J6 extending in an arm axial direction.

The head 17 is attached to a distal end of the sixth arm 16 via a force sensor FS to be described later. The head 17 serves as a support base for the end effector 18 and further serves as a mounting base for the manipulation handle 20 to be gripped by a user in direct teaching. The end effector 18 represents a structural member that performs a necessary work on a workpiece to be a work target. The end effector 18 may serve as a structural member configured to, for example, suck, weld, polish, or grip the workpiece.

FIG. 1 illustrates a tool center point (TCP) 19 of the end effector 18. The TCP 19 indicates a position to be a control reference point for the robot arm 10. For instance, the TCP 19 is settable to a position for sucking the workpiece by the end effector 18. Alternatively, the TCP 19 may be set to a gravity center position of the end effector 18 or any position relative to the end effector 18. Further alternatively, the TCP 19 may be set to a leading end of the robot arm 10.

The force sensor FS is a six-axis force detector located between the sixth arm 16 being the leading end of the robot arm 10 and the end effector 18. Specifically, the force sensor FS can simultaneously detect translational three axial force components in three axes of an x-axis, a y-axis, and a z-axis perpendicularly intersecting one another, and moment components around the x-axis, the y-axis, and the z-axis. The robot arm 10 may include a torque sensor in place of the force sensor FS.

The manipulation handle 20 is a member having a rod shape and protruding laterally outward from the head 17, and has a size suitable for gripping by the user with one hand. The user grips the manipulation handle 20 in the direct teaching to manually shift the TCP 19 of the robot arm 10 from one teaching point to another teaching point and teach an operational objective or a positional posture.

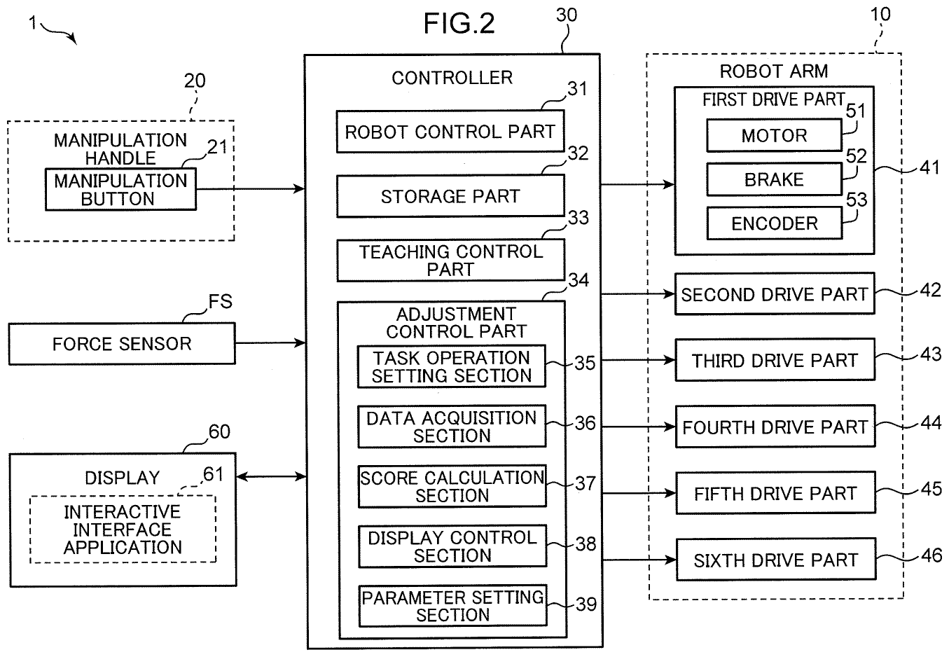

The controller 30 controls an operation of the robot arm 10 in accordance with teaching data given in advance. The controller 30 receives direct teaching of teaching an operational objective or a positional posture for the robot arm 10 manually by the user to generate the teaching data. The controller 30 further executes an adjustment control of adjusting a parameter to determine a manipulation feeling of the user about the robot arm 10 in the direct teaching. The controller 30 will be described in detail later with reference to FIG. 2.

The display 60 is composed of, for example, a tablet terminal and has various display functions related to the robotic system 1 and an input function of receiving a manipulation data input into the controller 30. Another device may be adoptable as the display 60 in substitution for the tablet terminal as long as the device has the display functions and the input function. The display 60 may include, for example, a personal computer, a smartphone, or a display and input screen dedicated to the robotic system 1.

### Electric Configuration of the Robotic System

FIG. 2 is a block diagram showing an electric configuration of the robotic system 1. The robot arm 10 incorporates a first drive part 41, a second drive part 42, a third drive part 43, a fourth drive part 44, a fifth drive part 45, and a sixth drive part 46 that give rotational driving forces respectively about the axes of the first shaft J1, the second shaft J2, the third shaft J3, the fourth shaft J4, the fifth shaft J5, and the sixth shaft J6. The first drive part 41 generates a rotational driving force for rotating the first arm 11 about the axis of the first shaft J1. Similarly, the second drive part 42 to the sixth drive part 46 generate rotational driving forces for rotating the second arm 12 to the sixth arm 16 respectively about the axes of the second shaft J2 to the sixth shaft J6.

The first drive part 41 includes a motor 51, a brake 52, and an encoder 53. The motor 51 is a drive source that generates the rotational driving force. The brake 52 regulates the rotational driving force from the motor 51. The brake 52 is activated to fix the first shaft J1. In other words, the brake 52 is activated to prohibit the motor 51 from rotationally driving and restrict the first arm 11 from rotating about the axis of the first shaft J1. The encoder 53 detects a rotation amount of the motor 51, that is, a rotation angle of the first arm 11. In addition, the first drive part 41 includes an unillustrated decelerator. The decelerator reduces a rotational speed of an output shaft of the motor 51 at a reduction ratio and transmits the reduced rotational speed to a rotation mechanism of the first shaft J1. Similarly, each of the second drive part 42 to the sixth drive part 46 includes a motor 51, a brake 52, an encoder 53, and a decelerator that work in the same manner as mentioned above.

The manipulation handle 20 has a manipulation button 21. The manipulation button 21 is manipulated by the user gripping the manipulation handle 20 in the direct teaching to validate a direct teaching mode. The manipulation handle 20 may have another manipulation button for executing another function, for example, a start button to start conduct of a task operation to be described later. Activation of the brake 52 of each of the first drive part 41 to the sixth drive part 46 is controlled and the fixed state of each of the first shaft J1 to the sixth shaft J6 serving as operational shafts is changed to enable restriction of a behavior of the robot arm 10 in the direct teaching. For instance, the manipulation handle 20 may have a manipulation button for selecting a mode of totally freely moving the robot arm 10 relative to the first shaft J1 to the sixth shaft J6 or a mode of moving the robot arm only on an xy-plane or a z-plane relative to the shafts.

The controller 30 receives an input of manipulation information about the manipulation button 21. The controller 30 further receives an input of data of the 6-axial force components detected by the force sensor FS as described above to utilize the data for a control of an operation of the robot arm 10 in the direct teaching and a control of an operation of the robot arm 10 in actual practice.

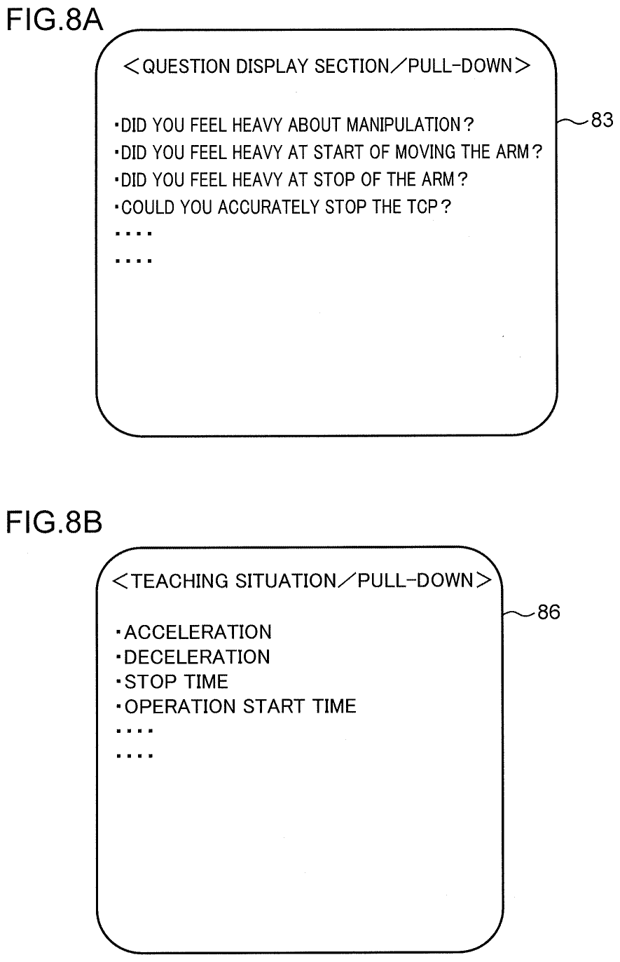

The display 60 incorporates an interactive interface application 61. The interactive interface application 61 represents application software to activate an interactive interface 8 illustrated in FIG. 8 in execution of the adjustment control on the parameter by the controller 30.

The controller 30 is a processor that executes various processes in accordance with a given program, and serves to functionally include a robot control part 31, a storage part 32, a teaching control part 33, and an adjustment control part 34 (controller) in response to execution of the program.

The robot control part 31 causes the robot arm 10 to operate on the basis of teaching data indicating an operational objective or a positional posture given in advance and causes the end effector 18 to perform a predetermined work on a workpiece in practical use of the robotic system 1 on a worksite. The storage part 32 stores the program and the teaching data. The storage part 32 further stores a parameter to determine a manipulation feeling in the direct teaching. The parameter may be desired to be set for a plurality of users individually, a type of an application of the robot arm 10, or a type of the end effector 18, and desired to be stored in the storage part 32 in association with a predetermined identification code or an ID.

The teaching control part 33 executes the direct teaching. Specifically, the teaching control part 33 causes the first arm 11 to the sixth arm 16 of the robot arm 10 to move in response to a movement force applied to the robot arm 10 by the user gripping the manipulation handle 20. The force sensor FS detects the movement force applied to the robot arm 10. The teaching control part 33 acquires a result of the detection and estimates a strength and a direction of the movement force. The teaching control part 33 appropriately drives the motor 51 of each of the first drive part 41 to the sixth drive part 46 on the basis of a result of the estimation and causes the robot arm 10 to move in a direction in which the user intends to move the robot arm 10. The teaching control part 33 further causes the storage part 32 to store, as the teaching data, the operational objective or the positional posture of the robot arm 10 set in the direct teaching.

The adjustment control part 34 executes an adjustment control of adjusting a parameter to determine a manipulation feeling, such as “heaviness” or “lightness”, in moving the robot arm 10 by the user in the direct teaching. Examples of the parameter include a viscosity coefficient, an inertia coefficient, a spring coefficient, and other parameters to be used in an impedance control to the first drive part 41 to the sixth drive part 46. The adjustment control generally includes the following steps (1) to (3):
(1) acquiring, on the basis of a result of causing the user to conduct a specific task operation manually with respect to the robot arm 10, the parameter and a predetermined evaluation index;
(2) calculating, on the basis of the evaluation index, a score being a mechanical evaluation value for the task operation, and presenting the score to the user; and
(3) changing the parameter depending on a subjective evaluation about the manipulation feeling by the user.

As shown in the steps (1) to (3), the adjustment control part 34 does not only adjust a parameter on the basis of a score obtained as a result of the conduct of the task operation in the step (1), but also presents the score to the user and changes the parameter depending on a subjective evaluation by the user as shown in the steps (2) and (3). This consequently enables setting of a parameter suitable for every user in consideration of a subjective of the user. The adjustment control part 34 serves to functionally include a task operation setting section 35, a data acquisition section 36, a score calculation section 37, a display control section 38, and a parameter setting section 39 in response to execution of a predetermined program.

The task operation setting section 35 sets a task operation imitating direct teaching to be conducted by the user for adjustment of a manipulation feeling. For instance, the task operation setting section 35 causes the display 60 to display a wizard of encouraging the user to conduct the task operation. Examples of the task operation include making the robot arm 10 have a specific posture, making the TCP 19 reciprocate at a specific distance, making the TCP 19 shift in a specific imitated work operation, and making the TCP 19 shift in a specific required manner with a jig for evaluation.

The data acquisition section 36 acquires various kinds of data obtainable as a result of conducting the task operation. The acquired data includes a parameter concerning a manipulation feeling, and a predetermined evaluation index. The parameter includes a viscosity coefficient, an inertia coefficient, and a spring coefficient in movement of the robot arm 10 in the conduct of the task operation. The evaluation index includes information about an operational accuracy of the robot arm 10 or the TCP 19. The operational accuracy is evaluated on the basis of, for example, whether the robot arm 10 has a posture exactly conforming to a model in the task operation, or whether the TCP 19 stops at a position exactly conforming to a designated position in the task operation.

The score calculation section 37 calculates, on the basis of the evaluation index, a score being an evaluation value in a result of the task operation. The score is calculated from evaluation elements including, for example, the posture accuracy of the robot arm 10 and the positional accuracy of the TCP 19 in the task operation, and a time required for the operation with reference to a predefined arithmetic expression and a predefined calculation table. Generally, a higher operational accuracy or a higher positional accuracy, and an operation time falling within a suitable range lead to a score with a high evaluation.

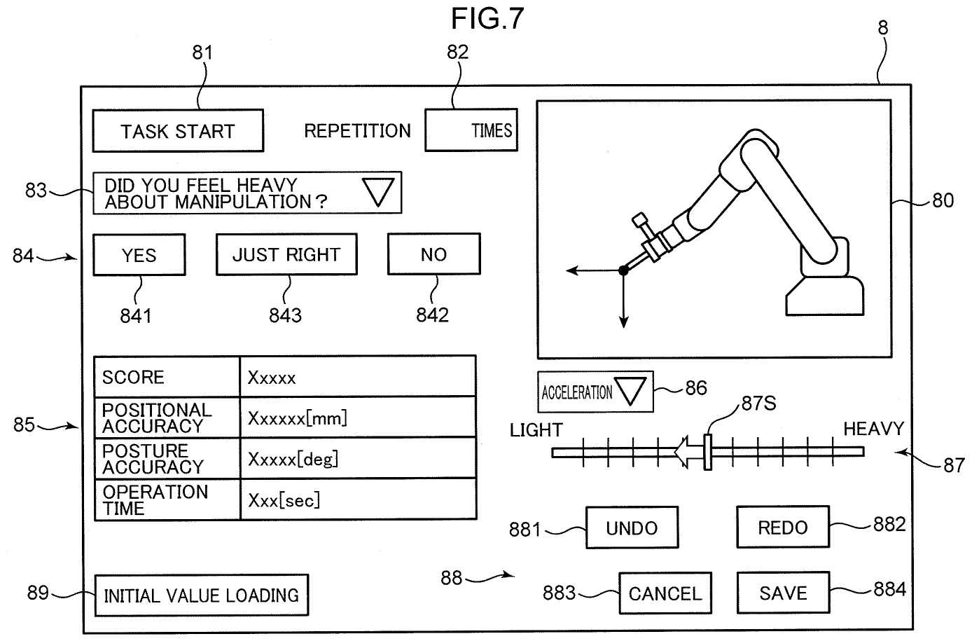

The display control section 38 causes the display 60 to display the score calculated by the score calculation section 37, and executes a display control of receiving a subjective evaluation about a manipulation feeling in the task operation by the user from the display 60. In a preferable embodiment, the display control section 38 allows the user to dynamically change the parameter by causing the display 60 to display the interactive interface 8 illustrated in FIG. 7, providing the interactive interface 8 with the score, and receiving the subjective evaluation by the user from the interactive interface 8.

The parameter setting section 39 changes the parameter obtained through the conduct of the task operation depending on the subjective evaluation by the user and stores the changed parameter in the storage part 32. The parameter setting section 39 stores, in the storage part 32, the adjusted parameter concerning the manipulation feeling in association with a user ID in such a manner as to be called up in execution of the direct teaching. The storage part 32 desirably stores the parameter for a type of an application of the robot arm 10 or a type of the end effector 18.

### Operation Process of the Adjustment Control

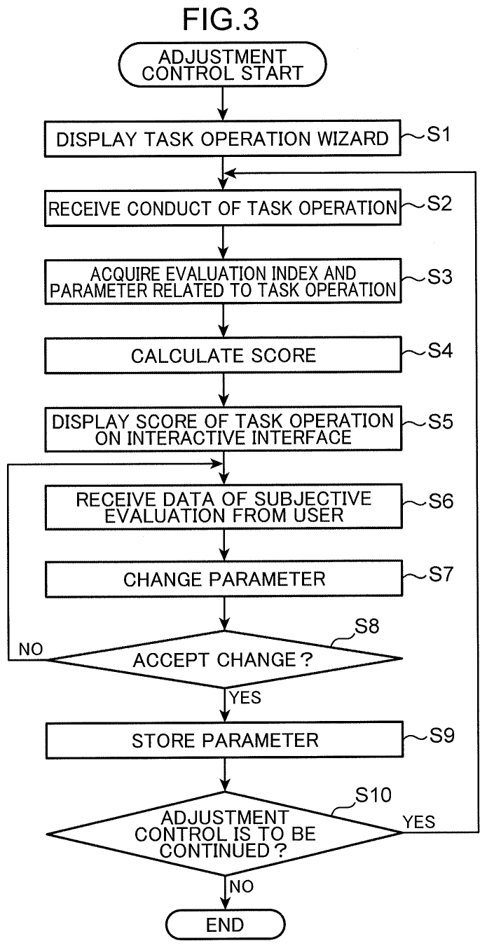

FIG. 3 is a flowchart showing an adjustment control on a parameter to determine a manipulation feeling in direct teaching. When execution of the adjustment control is selected, for example, with a mode selection switch in the robotic system 1, the task operation setting section 35 of the adjustment control part 34 causes the display 60 to display a wizard showing a procedure for conduct of a task operation (step S1).

When a user grips the manipulation handle 20 and applies a movement force to the robot arm 10 to conduct the task operation, the controller 30 receives the movement force (step S2). Specifically, in the same manner as the direct teaching, the teaching control part 33 drives the motor 51 of each of the first drive part 41 to the sixth drive part 46 to cause the robot arm 10 to move in a direction in which the user intends to move the robot arm 10 on the basis of a result of detection from the force sensor FS.

After the conduct of the task operation is received, the data acquisition section 36 acquires an evaluation index based on a result of the conduct of the task operation, and a parameter at the movement of the robot arm in the task operation (step S3). As already described above, examples of the evaluation index include a posture accuracy and a positional accuracy. The posture accuracy is obtainable from a coincidence between a rotation angle of each of the arms 11 to 16 set in the task operation and a corresponding rotation angle detected by the encoder 53 after the task operation. The positional accuracy is obtainable from a coincidence between a position of the TCP 19 in a robot operation coordinate set in the task operation and a position of the TCP after the task operation. The parameter indicates a value of a coefficient used in an impedance control in the conduct of the task operation.

When the evaluation index is acquired, the score calculation section 37 calculates, on the basis of the evaluation index, a score being an evaluation value of a result of the task operation (step S4). Subsequently, the display control section 38 causes the display 60 to activate the interactive interface 8 and display the score obtained in step S4 on the interactive interface 8 (step S5). The interactive interface 8 will be described in detail later with reference to FIG. 7.

Next, the display control section 38 receives an input of data of a subjective evaluation from the user on the interactive interface 8 (step S6). For instance, the interactive interface 8 displays a question about a manipulation feeling about the robot arm 10 and obtains answer information about the question to acquire information about a subjective evaluation of the manipulation feeling.

Then, the parameter setting section 39 changes the parameter acquired in step S3 on the basis of the score in step S5 (step S7). Specifically, when the score indicates a low value, the parameter is automatically modified to a parameter expected to give a score indicating a high value. For example, a too light manipulation feeling about the robot arm 10 makes it difficult to stop the TCP 19 at a target position, resulting in a lower score of a positional accuracy. In this example, the parameter is modified so that the manipulation feeling is heavier.

Further, in step S7, the parameter having been automatically modified is changed depending on the subjective evaluation received in step S6. In many cases, the user may feel discomfort with a manipulation feeling even at a score indicating a high value. In this respect, the parameter is defined to be changeable depending on the subjective evaluation. Example ways for such a change depending on a subjective evaluation include a way of causing the interactive interface 8 to directly receive a change manipulation by the user and a way of converting the subjective evaluation into a score and automatically modifying a parameter. As another way, the parameter setting section 39 may generate modification proposal information about modification of the parameter on the basis of information about the subjective evaluation, and the interactive interface 8 may display the modification proposal information.

Thereafter, the display control section 38 causes the display 60 to display options to ask the user whether to accept the change in the parameter (step S8). When the user refuses to accept the change in the parameter (NO in step S8), the process returns to step S6 to receive another input of data of a subjective evaluation by the user. When the user accepts the change in the parameter (YES in step S8), the parameter setting section 39 determines that adjustment of the parameter is completed and stores the parameter in the storage part 32 in association with a user ID (step S9).

Subsequently, it is confirmed whether to continue the adjustment control (step S10). For instance, when the adjustment control is confirmed to continue to conduct another task operation for the robot arm 10 or execute the adjustment control for the robotic system 1 by another user (YES in step S10), the process returns to step S2 to repeat the relevant steps. In contrast, when it is confirmed not to continue the adjustment control (NO in step S10), the adjustment control part 34 finishes the process.

### Examples of the Task Operation

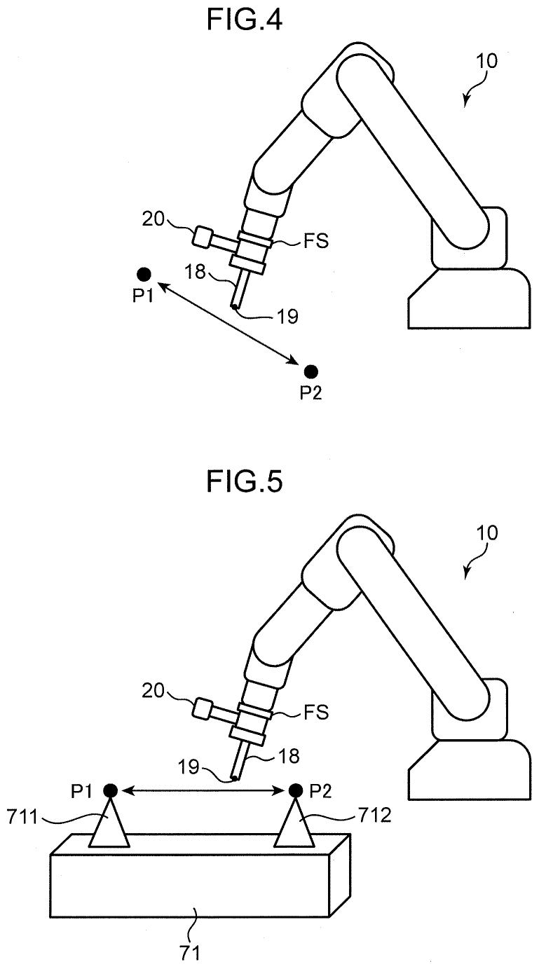

Each of FIG. 4 to FIG. 6 is an illustration of an example task operation to be conducted by a user. FIG. 4 shows a conduct situation of a task operation in a first example. In the first example, a user sets shifting target positions to specific positions P1, P2. The positions P1, P2 are set on, for example, an evaluation board or a piece of evaluation paper prepared by the user. The positions P1, P2 are registered in the controller 30 to serve as already known positions in an operation coordinate system of the robot arm 10.

The task operation in the first example represents an operation of causing the TCP 19 of the robot arm 10 to linearly reciprocate between the position P1 and the position P2. The user grips the manipulation handle 20 to manually shift the TCP 19 from the position P1 to the position P2, and then from the position P2 to the position P1. In the task operation, a posture of the robot arm 10, that is, a rotation angle of each of the first shaft J1 to the sixth shaft J6, may be registered. Further, a target operation speed related to a time required for the shifting between the position P1 and the position P2 may be set.

The score calculation section 37 compares, for example, a registered coordinate of the position P1, P2 with a trial coordinate of a stop position of the TCP 19 after the TCP 19 is manually shifted by the user toward the position P1, P2 being the target position and reaches the position P1, P2 in the task operation. Then, a score is calculated from a degree of discrepancy between the registered coordinate and the trial coordinate. Similarly, a score is calculated from a degree of discrepancy between a target rotation angle and a rotation angle of each of the first shaft J1 to the sixth shaft J6 after the task operation for the posture. Regarding the target operation speed, the adjustment control part 34 may issue an alarm when the task operation is conducted at an obviously abnormal speed. The abnormal speed means, for example, a speed exceeding an upper limit at which the direct teaching is safely executable, or a too low speed ignoring a takt time.

It is desirable that the user appropriately sets the number of repetition times of the task operation. Specifically, the number of times of reciprocation by the TCP19 between the position P1 and the position P2 is desirably selectable by the user. A larger number of repetition times achieves an averaged operation and enhanced precision about the score, but a long time is required to complete the task operation. In contrast, a smaller number of repetition times achieves saving of the time required for the task operation, but leads to lower precision about the score. It is desired to leave the choice to the user for giving importance to the precision or the time.

FIG. 5 shows a conduct situation of a task operation in a second example. The second example shows use of a jig 71 to determine a shifting target position of the TCP 19 in the task operation. The jig 71 is a jig for setting a linear shifting target, and includes a first reference protrusion 711 and a second reference protrusion 712. The first reference protrusion 711 has a vertex set to a position P1 to be a reference position, and the second reference protrusion 712 has a vertex set to a position P2 to be another reference position. For example, the jig 71 is provided by a robot manufacturer and is ensured to have a positional accuracy for each of the positions P1, P2. This achieves improvement in the precision about the score calculated by the score calculation section 37. Positions to be reference positions are not limited to the two positions P1, P2, and three or more reference positions may be set in this example and in the preceding first example.

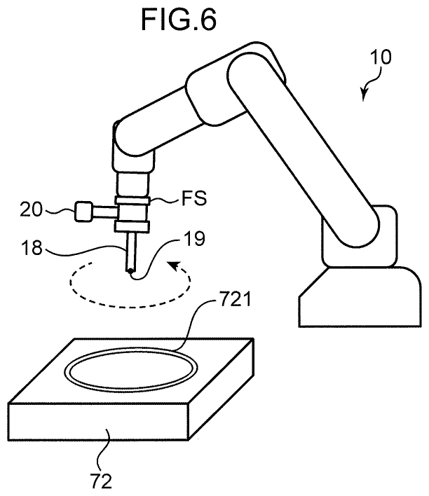

FIG. 6 shows a conduct situation of a task operation in a third example. In the third example, the task operation includes causing the TCP 19 to draw a circular orbit. In the first and the second examples, the TCP 19 is made reciprocate between the positions P1 and P2. Instead, in the third example, the task operation may include starting from a certain reference position, drawing a predetermined orbit, e.g., a circular orbit, and thereafter, returning to the reference position.

It is difficult to actually shift the TCP 19 to draw such a circular orbit in a real space. From this perspective, a circular orbit teaching jig 72 is preferably used to cause the TCP 19 to draw the circular orbit, and the controller 30 desirably registers the circular orbit to be a reference. The circular orbit teaching jig 72 has an annular groove 721 on an upper surface thereof to receive the end effector 18 therein. For the registration of the circular orbit, the user makes the TCP 19 circle along the annular groove 721 with the end effector 18 fitted in the annular groove 721. A rotation angle of each of the first shaft J1 to the sixth shaft J6 and a circle coordinate of the TCP 19 are registered on the basis of an output value from the force sensor FS at the circling. In the task operation, the user moves the robot arm 10 in such a manner that the TCP 19 draws a circular orbit without using the jig 72. The score calculation section 37 calculates a score on the basis of displacement of the circular orbit in the task operation from the registered circular orbit.

### Specific Example of the Interactive Interface

FIG. 7 is an illustration of an example of the interactive interface 8 which the display control section 38 causes the display 60 to display in the adjustment control. The interactive interface 8 includes a robot image display section 80, a task situation display section 81, a number-of-times input section 82, a question display section 83, an answer section 84, a score display section 85, a teaching situation display section 86, a slide bar 87 (parameter adjustment section), a command button group 88, and an initial value loading button 89.

The robot image display section 80 displays a robot to be subjected to an adjustment control on a parameter to determine a manipulation feeling in direct teaching. In addition, the robot image display section 80 may display a model number and a type of the robot, an arrangement position of the robot in a factory, a work step in charge, and other information together.

The task situation display section 81 is a section that displays a situation of conducting a task operation. The example in FIG. 7 show letters of “Task Start” to indicate start of the task operation. For instance, when the task operation is completed, letters of “Task End” is displayed. The task situation display section 81 may display information including guidance for the task operation, assistive information, an error, and issuance of an abnormality in detail in a dialog box.

The number-of-times input section 82 receives an input of setting of the number of repetition times of the task operation from the user. The task operation setting section 35 is an input section that receives the conduct of the same task operation for the number of repetition times associated with the input into the number-of-times input section 82. Adjustment of the number of repetition times leads to adjustment of a time required for the conduct of the task operation by the user. As aforementioned, increasing the number of repetition times achieves improvement in the precision about the score for the task operation, but a long time is required for the conduct of the task operation. Such setting of the number-of-times input section 82 allows the user to adjust the number of repetition times in terms of the merits and demerits described above.

The question display section 83 is a display section that displays a question about a manipulation feeling about the robot arm 10 in the task operation to the user. The question display section 83 is defined to enable displaying of some question sentences prepared in advance in a pull-down manner. FIG. 8A shows question examples to be displayed in the pull-down manner in the question display section 83. The drawing exemplifies the following questions about manipulation feelings which the user might directly have: “Did you feel heavy about manipulation?”; “Did you feel heavy at start of moving the arm?”; “Did you feel heavy at stop of the arm?”; and “Could you accurately stop the TCP?”. These questions may be displayed one after another in a dialog box.

The answer section 84 receives, from the user, an answer to a question displayed in the question display section 83. The answer section 84 has a first selection button 841 to be selected in a discomfort about a manipulation feeling corresponding to a question, a second selection button 842 to be selected in a discomfort about the manipulation feeling contrary to the question, and a third selection button 843 to be selected in no discomfort designated by the question. FIG. 7 illustrates example displaying of the first selection button 841 showing “Yes”, the second selection button 842 showing “No”, and the third selection button 843 showing “Just right” for the question “Did you feel heavy about manipulation?”. The displaying of each of the first, second, and third selection buttons 841, 842, and 843 may be appropriately changed in accordance with a question. Such setting of the answer section 84 enables reliable acquisition of the manipulation feeling of the user in the task operation, and leads to achieved setting of a manipulation feeling parameter that reflects the feeling of the user.

The score display section 85 is a display section that displays a score mechanically calculated by the score calculation section 37 on the basis of a result of the conduct of the task operation. The score display section 85 is further desired to display an evaluation index as grounds for the calculation of the score. FIG. 7 illustrates displayed examples of the evaluation index including a positional accuracy of the TCP 19 and a posture accuracy of the robot arm 10 in the task operation, and a time required for the conduct of the task operation.

The teaching situation display section 86 is a section for selecting a situation of the direct teaching. The teaching situation display section 86 is defined to enable displaying of some situations prepared in advance in a pull-down manner. FIG. 8B shows situations to be displayed in the teaching situation display section 86 in a pull-down manner. The drawing exemplifies situations including: “acceleration” and “deceleration” respectively meaning accelerated movement and decelerated movement of the robot arm 10; “stop time” meaning a time to stop the TCP 19; and an “operation start time” meaning a time to start shifting of the TCP19 in direct teaching. Such options are given to enable setting of a parameter suitable for the user for every situation at the acceleration, at the deceleration, at the stop time, and at the operation start time in the direct teaching.

The slide bar 87 is a section to directly receive, from the user, an input of a change in a parameter concerning a manipulation feeling, and has a slider 87S for adjustment of the parameter. The slider 87S is slid on the slide bar 87 to change the parameter for a “light” manipulation feeling or a “heavy” manipulation feeling. The parameter setting section 39 changes the parameter concerning the manipulation feeling in response to information input into the slide bar 87, that is, in response to the sliding of the slider 87S.

Various ways can be exemplified for changing a parameter concerning a manipulation feeling. One way includes automatically modifying a parameter by the parameter setting section 39 on the basis of information about a subjective evaluation by the user input into the answer section 84. In this case, the parameter setting section 39 automatically modifies the parameter in two stages. Specifically, the parameter setting section 39 automatically modifies the parameter on the basis of a score mechanically calculated by the score calculation section 37, and further automatically modifies the parameter with a predetermined formula to which a normalized subjective evaluation by the user is applied. For instance, when the question display section 83 displays the question “Did you feel heavy about manipulation?” and the user selects the first selection button 841=“YES” in the answer section 84, the parameter setting section 39 automatically modifies the parameter for a lighter manipulation feeling. This way attains rapid completion of changing the parameter owing to the automatic modification of the parameter.

Another way includes receiving a subjective evaluation by the user through a manual manipulation to the slide bar 87, and modifying the parameter by the parameter setting section 39. For instance, a center position of the slider 87S on the slide bar 87 is defined to indicate a value of the parameter modified on the basis of a score calculated by the score calculation section 37. The parameter is modified from such a set default state depending on the subjective evaluation in response to the manipulation to the slider 87S by the user. For example, the user having a heavy manipulation feeling can modify the parameter for a lighter manipulation feeling by sliding the slider 87S leftward. This way enables direct linking of the manipulation feeling of the user to the change in the parameter. Here, after the automatic modification of the parameter in response to the answer in the answer section 84 in the preceding example, further manual modification to the parameter by the user may be received through the slide bar 87.

On an actual worksite, a user may find it difficult to determine a manipulation feeling. Taking this into account, modification proposal information about modification of a parameter may be generated on the basis of information about a subjective evaluation acquired in the answer section 84, and the interactive interface 8 may display the modification proposal information. For instance, when the user answers “YES” to the question “Did you feel heavy about manipulation?” in the question display section 83, the interactive interface 8 may display modification proposals “Slide the slider 87S leftward by one scale”, “Slide the slider 87S toward ‘light’”, or other proposal in a pop-up display manner. The way includes presenting recommendable modification proposal information to the user on the interactive interface 8. This results in achievement in providing such a user finding it difficult to determine a manipulation feeling with assistive information for the determination.

The command button group 88 includes an “Undo” button 881, a “Redo” button 882, a cancellation button 883, and a save button 884. The “Undo” button 881 is pressed to cancel a temporarily set parameter concerning a manipulation feeling. The “Redo” button 882 is pressed to restore the setting cancelled with the “Undo” button 881. The cancellation button 883 is pressed to cancel an adjustment control executed until then. The save button 884 is pressed to confirm registration of the parameter derived under the adjustment control.

The initial value loading button 89 is used to load an already existing parameter as an initial value. Examples of the already existing parameter include a parameter adjustment value obtained in adjustment executed in a robot used in past and a parameter adjustment value related to another user. Such parameter adjustment values can be read out from the storage part 32 of the controller 30, or can be downloaded from another controller, a USB memory, or a web site. This way introduces an already existing parameter associated with succeeded adjustment as a default value, and thus achieves saving of a time required for adjustment of a parameter.

The embodiment exemplifies receiving of the conduct of the same task operation for the number of times associated with an input of setting into the number-of-times input section 82 of the interactive interface 8. Instead, the conduct of the task operation may be finished in a case where a predetermined condition is satisfied or a finish instruction from the user is received before the conduct of the task operation reaches the set number of repetition times.

For example, a user inputs a subjective evaluation into the answer section 84 every one time of the task operation. In this example, in a case where the user has an optimal manipulation feeling in a specific turn of the task operation before the conduct of the task operation reaches the number of repetition times, the repetition of the task operation may be finished in the turn in response to a finish instruction from the user. Alternatively, in connection with a subjective evaluation for every turn of the task operation, when the evaluation “just right” is continuously selected for a predetermined number times or when the evaluation “just right” is not continuously selected but selected to reach the predetermined number of times, the repetition of the task operation may be automatically finished. When the repetition of the evaluation “heavy” or “light” continues for a predetermined number of times, the repetition may be automatically finished on the basis of determination that the subjective evaluation is deemed inconsistent. In the case of the automatic finish, the task situation display section 81 on the interactive interface 8 is desired to display, for example, “Task End”.

The robotic system 1 or a method for adjusting a parameter according to the embodiment described heretofore is defined not to set a parameter to determine a manipulation feeling in direct teaching by causing a user to input a numerical value, but to adjust the parameter by causing the user to conduct a task operation. This configuration allows even a user having less expert knowledge to easily set a comfortable manipulation feeling. Besides, the parameter is not only adjusted on the basis of a score calculated by the score calculation section 37 referring to a result of the conduct of the task operation, but also is presented to the user on the interactive interface 8, and further a subjective evaluation by the user is received from the answer section 84 or via the slide bar 87, so that the parameter is changed. This consequently enables setting of a parameter suitable for every user in consideration of a subjective of the user.

### Features Covered by the Embodiment

The embodiment covers each disclosure to be described below.

A robotic system according to one aspect of the present disclosure includes a robot configured to perform a predetermined operation; and a controller configured to receive direct teaching of teaching an operational objective for the robot manually by a user and control the operation of the robot. The controller executes an adjustment control of adjusting a parameter to determine a manipulation feeling in the direct teaching, and is configured to, in the adjustment control: acquire, on the basis of a result of causing the user to conduct a specific task operation manually with respect to the robot, the parameter concerning the manipulation feeling and a predetermined evaluation index; calculate, on the basis of the evaluation index, a score being a mechanical evaluation value for the task operation and presenting the score to the user; and change the parameter depending on a subjective evaluation about the manipulation feeling by the user.

A method for adjusting a parameter according to another aspect of the present disclosure is a method for adjusting a parameter to determine a manipulation feeling in direct teaching of teaching an operational objective for a robot manually by a user, the direct teaching being executable in a robotic system. The method includes causing the user to conduct a specific task operation manually with respect to the robot; deriving, on the basis of a result of the conduct of the task operation, the parameter concerning the manipulation feeling and a predetermined evaluation index; calculating, on the basis of the evaluation index, a score being a mechanical evaluation value for the task operation, and presenting the score to the user; and changing the parameter depending on a subjective evaluation about the manipulation feeling by the user.

The robotic system or the method for adjusting a parameter is defined not to set a parameter to determine a manipulation feeling in direct teaching directly by the user, but to adjust the parameter by causing the user to conduct a task operation. This configuration allows even a user having less expert knowledge to easily set a comfortable manipulation feeling. The parameter is not only adjusted on the basis of a score obtained as a result of the conduct of the task operation, but also is presented to the user, so that the parameter is changed depending on a subjective evaluation by the user. This consequently enables setting of a parameter suitable for every user in consideration of a subjective of the user.

In the robotic system, the evaluation index desirably includes information about an operational accuracy of the robot.

The configuration enables calculation of the score based on the evaluation index about the operational accuracy of the robot in the task operation. This attains adjustment of the parameter with a score based on a high operational accuracy in addition to preference of the user.

The robotic system preferably further includes a display configured to display an interactive interface. It is preferable that the controller is configured to dynamically change the parameter by providing the interactive interface with the score and receiving the subjective evaluation by the user from the interactive interface.

The configuration that receives the subjective evaluation by the user on the interactive interface easily enables adjustment of the parameter to eliminate a discrepancy between a score being a mechanical evaluation value and a manipulation feeling which the user actually has in the direct teaching.

In the robotic system, the controller may be configured to: cause the interactive interface to display a question display section that displays a question about the manipulation feeling to the user and an answer section that receives an answer to the question from the user; and acquire information about the subjective evaluation by the user on the basis of information input into the answer section.

The configuration enables reliable acquisition of a manipulation feeling of the user on the basis of the answer to the question about the manipulation feeling. This consequently achieves setting of a parameter that reflects the feeling of the user.

In the robotic system, the controller may be configured to generate modification proposal information about modification of the parameter on the basis of the acquired information about the subjective evaluation, and cause the interactive interface to display the modification proposal information.

The configuration enables presentation of recommendable modification proposal information to the user on the interactive interface. This results in achievement in providing, for example, such a user finding it difficult to determine a manipulation feeling with assistive information for the determination.

In the robotic system, the controller may be configured to automatically modify the parameter on the basis of the acquired information about the subjective evaluation.

The configuration attains rapid completion of changing the parameter owing to the automatic modification of the parameter.

In the robotic system, the controller may be configured to: cause the interactive interface to display a parameter adjustment section that receives a change in the parameter from the user; and change the parameter on the basis of information input into the parameter adjustment section.

The configuration enables direct linking of the manipulation feeling of the user to the change in the parameter. For instance, the interactive interface is defined to display an option, for example, to allow the user to make the manipulation feeling “light” or “heavy” through manipulation, so that the user can directly adjust the parameter in accordance with the feeling of the user.

In the robotic system, the controller is configured to desirably cause the interactive interface to display a loading button to load an existing parameter as an initial value.

The configuration introduces an already existing parameter as a default value, and thus achieves saving of a time required for adjustment of a parameter. Examples of the already existing parameter include a parameter adjustment value obtained in adjustment executed in a robot used in past and a parameter adjustment value related to another user.

In the robotic system, the controller may be configured to: cause the interactive interface to display a number-of-times input section that receives an input of setting of the number of repetition times of the task operation; and allow the conduct of the same task operation for the number of repetition times associated with the input of setting.

The configuration enables adjustment of the time required for the conduct of the task operation by the user. Increasing the number of repetition times achieves improvement in the precision about the score for the task operation, but a long time is required for the conduct of the task operation. This configuration allows the user to adjust the number of repetition times in terms of the merits and demerits.

In the robotic system, the controller may be configured to finish the conduct of the task operation in a case where a predetermined condition is satisfied or the controller receives a finish instruction from the user before the conduct reaches the number of repetition times associated with the input of setting.

This configuration enables stop of the conduct of the task operation when an appropriate adjustment of the parameter is executable without repetition of the task operation. This eliminates substantially unnecessary repletion of the conduct of the task operation to thereby achieve saving of a time required for the adjustment of the parameter.

In the robotic system, the controller may be configured to execute the adjustment control at acceleration, at deceleration, at a stop time, and an operation start time of the robot individually in the direct teaching.

This configuration enables setting of a parameter suitable for the user for every situation at the acceleration, at the deceleration, at the stop time, and at the operation start time in the direct teaching.

The robotic system may further include a storage part that stores the parameter. The controller may be configured to execute the adjustment control for a plurality of the users individually, for a type of an application of the robot, or for a type of an end effector; and cause the storage part to store the adjusted parameter in such a manner as to be called up in execution of the direct teaching.

This configuration enables setting of the parameter for every user, a type of an application, or a type of an end effector, and thus achieves adjustment of the manipulation feeling in the direct teaching in more detail.

Conclusively, the present disclosure can provide a robotic system that enables comfortable direct teaching for a user, and a method for adjusting a parameter.

1. A robotic system, comprising:
a robot configured to perform a predetermined operation; and
a controller configured to receive direct teaching of teaching an operational objective for the robot manually by a user and control the operation of the robot, wherein
the controller is configured to execute an adjustment control of adjusting a parameter to determine a manipulation feeling in the direct teaching, and is configured to, in the adjustment control:
acquire, on the basis of a result of causing the user to conduct a specific task operation manually with respect to the robot, the parameter concerning the manipulation feeling and a predetermined evaluation index;
calculate, on the basis of the evaluation index, a score being a mechanical evaluation value for the task operation, and present the score to the user; and
change the parameter depending on a subjective evaluation about the manipulation feeling by the user.

2. The robotic system according to claim 1, wherein the evaluation index includes information about an operational accuracy of the robot.

3. The robotic system according to claim 1, further comprising a display configured to display an interactive interface, wherein
the controller is configured to dynamically change the parameter by providing the interactive interface with the score and receiving the subjective evaluation by the user from the interactive interface.

4. The robotic system according to claim 3, wherein the controller is configured to:
cause the interactive interface to display a question display section that displays a question about the manipulation feeling to the user and an answer section that receives an answer to the question from the user; and
acquire information about the subjective evaluation by the user on the basis of information input into the answer section.

5. The robotic system according to claim 4, wherein the controller is configured to generate modification proposal information about modification of the parameter on the basis of the acquired information about the subjective evaluation, and cause the interactive interface to display the modification proposal information.

6. The robotic system according to claim 4, wherein the controller is configured to automatically modify the parameter on the basis of the acquired information about the subjective evaluation.

7. The robotic system according to claim 3, wherein the controller is configured to:
cause the interactive interface to display a parameter adjustment section that receives a change in the parameter from the user; and
change the parameter on the basis of information input into the parameter adjustment section.

8. The robotic system according to claim 3, wherein the controller is configured to cause the interactive interface to display a loading button to load an existing parameter as an initial value.

9. The robotic system according to claim 3, wherein the controller is configured to:
cause the interactive interface to display a number-of-times input section that receives an input of setting of the number of repetition times of the task operation; and
allow the conduct of the same task operation for the number of repetition times associated with the input of setting.

10. The robotic system according to claim 9, wherein the controller is configured to finish the conduct of the task operation in a case where a predetermined condition is satisfied or the controller receives a finish instruction from the user before the conduct reaches the number of repetition times associated with the input of setting.

11. The robotic system according to claim 1, wherein the controller is configured to execute the adjustment control at acceleration, at deceleration, at a stop time, and an operation start time of the robot individually in the direct teaching.

12. The robotic system according to claim 1, further comprising:
a storage configured to store the parameter, wherein
the controller is configured to:
execute the adjustment control for a plurality of the users individually, for a type of an application of the robot, or for a type of an end effector; and
cause the storage to store the adjusted parameter in such a manner as to be called up in execution of the direct teaching.

13. A method for adjusting a parameter to determine a manipulation feeling in direct teaching of teaching an operational objective for a robot manually by a user, the direct teaching being executable in a robotic system, the method comprising:
causing the user to conduct a specific task operation manually with respect to the robot;
deriving, on the basis of a result of the conduct of the task operation, the parameter concerning the manipulation feeling and a predetermined evaluation index; and
calculating, on the basis of the evaluation index, a score being a mechanical evaluation value for the task operation, and presenting the score to the user; and
changing the parameter depending on a subjective evaluation about the manipulation feeling by the user.

14. The robotic system according to claim 2, further comprising a display configured to display an interactive interface, wherein
the controller is configured to dynamically change the parameter by providing the interactive interface with the score and receiving the subjective evaluation by the user from the interactive interface.
